(19) United States
(12) Patent Application Publication
(10) Pub. No.: US 2025/0123213 A1
(43) Pub. Date: Apr. 17, 2025

(54) MONITORING OF HF IN BUFFERED HYDROFLUORIC ACID (BHF)

(71) Applicant: KLA Corporation, Milpitas, CA (US)

(72) Inventors: Jingjing Wang, Livingston, NJ (US); Patrick Saitta, New York, NY (US); Eugene Shalyt, Washington Township, NJ (US)

(73) Assignee: KLA Corporation, Milpitas, CA (US)

(21) Appl. No.: 18/790,818

(22) Filed: Jul. 31, 2024

Related U.S. Application Data
(60) Provisional application No. 63/543,983, filed on Oct. 13, 2023.

(51) Int. Cl. G01N 21/67; G01N 21/359

(52) U.S. Cl. CPC G01N 21/67; G01N 21/359

(57) ABSTRACT

The disclosed subject matter relates to method for determining HF concentration in highly buffered hydrofluoric acid (BHF), with e.g., <1000 ppm HF and >15 wt. % NH₄F, through measurement of etched Si concentration and NH₄F, which demonstrates a substantial accuracy and reliability in detection.

### CROSS-REFERENCE TO RELATED APPLICATIONS

This application claims priority to U.S. Provisional Patent Application Ser. No. 63/543,983 filed Oct. 13, 2023, the contents of which are hereby incorporated by reference herein in its entirety.

### BACKGROUND

The disclosed subject matter relates to techniques for monitoring of HF in buffered hydrofluoric acid (BHF) through measurement of etched Si concentration.

BHF solution is a mixture of a buffering agent, typically including ammonium fluoride (NH₄F) and hydrofluoric acid (HF). In the semiconductor manufacturing field, NH₄F (typically 40% NH₄F in water) and HF (typically 49% HF in water) are mixed at various ratios to etch SiO₂. The control of the etch bath composition is necessary for an effective bath use, for the replenishment of the consumed components, and to maintain a certain etch rate.

The ratio of NH₄F over HF can have an important impact on the etch rate. As the scaling of semiconductor devices continues, etching of small features can require high NH₄F/HF ratios. It can be difficult to measure highly diluted HF (e.g., <1000 ppm) in relatively concentrated NH₄F (e.g., >15 wt. %). Certain methods including acid-base titrations (either potentiometric or thermometric), pH measurement, fluoride ISE, and spectroscopy can provide an inaccurate determination of HF due to the presence of NH₄F, especially with a molar concentration >500-fold higher than HF.

Accordingly, there is a need for sustainably, efficiently, and accurately monitoring HF in buffered hydrofluoric acid (BHF) through measurement of etched Si concentration.

### SUMMARY

To solve the problems of inaccuracy, non-reliability, and non-repeatability, the disclosed subject matter provides methods for monitoring of HF in a highly diluted BHF solution. Embodiments of the disclosed subject matter determine HF concentration in BHF solution via the measurement of etched Si and NH₄F concentration.

The disclosed matter provides methods for monitoring of HF in buffered hydrofluoric acid (BHF). An example method includes etching SiO₂ by using a BHF solution containing HF and NH₄F, measuring Si concentration, calibrating a correlation between the etched Si concentration (or etch rate) and HF concentration in BHF solution, measuring NH₄F concentration, and determining HF concentration.

In certain embodiments, the BHF solution comprises HF less than 1000 ppm.

In certain embodiments, the BHF solution comprises NH₄F more than 15 wt. %.

In certain embodiments, the Si concentration is measured by inductively coupled plasma optical emission spectroscopy (ICP-OES) or spectrophotometric techniques.

In certain embodiments, the method includes calculating an etch rate at least based on etched Si, the surface area of SiO₂ and etch duration time.

In certain embodiments, the NH₄F concentration is measured by NIR spectroscopy.

In certain embodiments, the correlation is linearly positive, wherein with the concentration of etched Si increasing, the HF concentration increases.

In certain embodiments, the monitoring conditions are maintained consistent.

In certain embodiment, the monitoring conditions comprise solution volume, mixing rotation rate, mixing time, and temperature.

In certain embodiments, the method further comprises compensating NH₄F into the BHF solution for avoiding a large variation during the monitoring.

### BRIEF DESCRIPTION OF THE DRAWINGS

The application file contains at least one drawing executed in color. Copies of this publication with color drawing(s) will be provided by the Office upon request and payment of the necessary fee.

Reference will now be made in detail to the various exemplary embodiments of the disclosed subject matter, which are illustrated in the accompanying drawings. The accompanying drawings, where like reference numerals refer to identical or functionally similar elements throughout the separate views, serve to further illustrate various embodiments and to explain various principles and advantages all in accordance with the disclosed subject matter.

FIG. 1 provides a schematic flow showing an exemplary monitoring process for HF in BHF solution according to an embodiment of the disclosed subject matter.

FIG. 2 provides a plot of etched Si versus different HF concentrations in BHF solution according to an embodiment of the disclosed subject matter.

FIG. 3 provides an UVVIS spectra of a BHF sample after being treated with chromophores that react with etched Si selectively according to an embodiment of the disclosed subject matter.

FIG. 4 provides a plot showing a correlation of measured versus prepared HF in BHF solution according to an embodiment of the disclosed subject matter.

FIG. 5 provides a plot showing simulated pH versus initial HF concentration in NH₄F/HF/H₂O system according to a compared embodiment.

FIG. 6 provides a dot data map showing a comparison of measured and prepared HF in HF/NH₄F solutions by NIR method according to a compared embodiment.

It is to be understood that both the foregoing general description and the following detailed description are exemplary and are intended to provide further explanation of the disclosed subject matter.

### DETAILED DESCRIPTION

The disclosed matter provides techniques for monitoring HF in BHF solution through measurement of etched Si concentration. The embodiments of the present disclosure are suitable for analysis of etched Si baths comprising hydrofluoric acid.

The terms used in this specification generally have their ordinary meanings in the art, within the context of this disclosure and in the specific context where each term is used. Certain terms are discussed below, or elsewhere in the specification, to provide additional guidance to the practitioner in describing the compositions and methods of the disclosed subject matter and how to make and use them.

For purposes of interpreting this specification, the following definitions will apply and whenever appropriate, terms used in the singular will also include the plural and vice versa.

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, up to 10%, up to 5%, and up to 1% of a given value.

As used herein, the term “buffered hydrofluoric acid (short for BHF)” refers to a type of solution including a mixture of a primary etchant HF and a buffering agent, such as ammonium fluoride (NH₄F). A buffering agent, such as ammonium fluoride (NH₄F), is added to the HF solution to stabilize its pH. This buffer helps prevent the solution from becoming too acidic during the etching process and provides more control over the etch rate. The specific ratio of HF to the buffering agent and other additives can vary depending on the intended application and the desired properties of the BHF solution. For example, in the context of silicon dioxide etching, BHF allows for selective removal of SiO₂ while leaving other materials intact. The buffer system ensures that the pH of the solution remains within a controlled range, which is critical for achieving precise and reproducible etching rates. In certain embodiments of the present disclosure, the ratio of NH₄F to HF in the BHF solution can be adjusted to control the etch rate. Higher concentrations of HF relative to NH₄F can lead to faster etch rates. BHF is often used for selective etching, where it removes SiO₂ while leaving other materials unaffected. The selectivity of the etching process is an important consideration in many applications.

As used herein, the term “etch rate”, often short for “ER,” represents the rate at which a material is removed or dissolved during a chemical etching process. Etching involves selectively removing specific materials from a substrate or wafer to create patterns or structures. The etch rate is typically measured in units including, but not limiting to, nanometers per minute (nm/min), angstroms per second (Å/s), or angstroms per minute (Å/min) and provides insights into the speed of the etching process. Typically, the etch rate of SiO₂ increases with higher HF concentrations up to a certain point, beyond which it may saturate or reach a plateau. The exact relationship between etch rate and HF concentration can be influenced by several factors, including temperature, pressure, and the presence of other additives.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 as well as all intervening decimal values between the aforementioned integers such as, for example, 1.1, 1.2, 1.3, 1.4, 1.5, 1.6, 1.7, 1.8, and 1.9. Ranges disclosed herein, for example, “between about X and about Y” are, unless specified otherwise, inclusive of range limits about X and about Y as well as X and Y. With respect to sub-ranges, “nested sub-ranges” that extend from either endpoint of the range are specifically contemplated. For example, a nested sub-range of an exemplary range of 1 to 50 can include 1 to 10, 1 to 20, 1 to 30, and 1 to 40 in one direction, or 50 to 40, 50 to 30, 50 to 20, and 50 to 10 in the other direction.

As used herein, the term “predetermined concentration” refers to a known, target, standard or optimum concentration of a component in a solution.

As used herein, the term “selective” or “selectively” refers to, for example, the particular monitoring, measurement, or determination of a characteristic of a specific or particular component. For example, the selective measurement of an ion refers to the measurement of one particular or predetermined target ion from a plurality of the ions present in solution.

As used herein, the term “accurate” or “accurately” refers to, for example, a measurement or determination that is relatively close to or near an existing or true value, standard, or known measurement or value. In certain embodiments, the measurement or determination accuracy error is less than ±5.0%, having a standard deviation less than 0.02, and/or a residual standard deviation (RSD) less than 2%.

As used herein, the term “processing solution/bath”, “target solution/bath”, or “sample solution/bath” refers to a chemical solution which is used to analyze the concentration of a substance in the solution by reacting it with a known amount of a standard solution.

As used herein, the term “UV-VIS spectrum”, short for ultraviolet-visible spectrum, refers to a graphical representation of how a sample absorbs light at different wavelengths in the ultraviolet (UV) and visible (VIS) regions of the electromagnetic spectrum. A UV-VIS spectrum shows absorption peaks where the sample absorbs light most strongly. The intensity of these peaks is typically plotted on the y-axis, while the wavelength (or energy) is plotted on the x-axis.

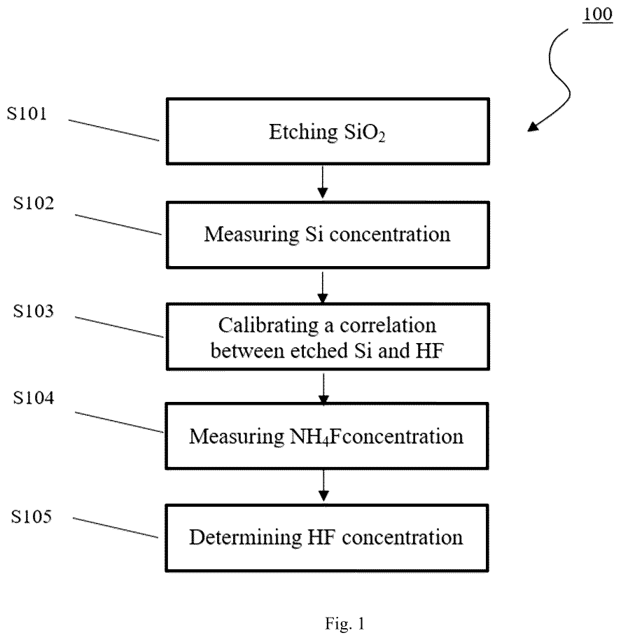

In particular embodiments, an exemplary process for the present monitoring method of HF in BHF solution can be illustrated, as shown in FIG. 1.

At 101, etching of SiO₂ takes place with a BHF sample solution.

At 102, Si concentration is measured. This can involve ICP-OES or spectrophotometric techniques. The measurement of Si can be provided for a following calculation of SiO₂ etch rate. In the disclosed subject matter, Si detection by either method exhibits good agreement between measured and prepared HF.

At 103, a correlation between etched Si and HF concentration is calibrated, based on the above measurement. The concentration of etched Si related to the concentration of HF and NH₄F in the sample solution. Therefore, when etched Si and NH₄F concentration are determined, the concentration of HF can be calculated and monitored.

Alternatively, an etch rate may be calculated in the process for verifying the correlation of etched Si and HF. For example, the etch rate in certain embodiments can be calculated based on the concentration of Si, SiO₂ surface area, and etch duration. In certain embodiments, the etch rate of SiO₂ can be expressed in units of angstroms per minute (Å/min), where an angstrom (A) is a unit of length equal to 0.1 nanometers (nm).

At 104, the NH₄F concentration in the BHF is measured. For example, NH₄F can be measured by NIR spectroscopy, whose readout is used as one of the inputs to calculate the final HF concentration. Also, considering the large variation of NH₄F in the sample solution, the measurement of NH₄F can provide a threshold whether apply a compensation of NH₄F at an appropriate ratio.

At 105, the HF concentration is determined. During the etch process, the concentration of etched Si is only related to the concentration of HF and NH₄F in the sample solution. Via the above measurements, the HF concentration in BHF solution can be calculated accordingly. For example, a correlation between etched Si and HF is determined at 103, and another correlation between HF and NH₄F is determined at 104. Subsequently, HF concentration can be calculated according to the following equation:

$${C}_{H F} = Offset + {Factor}_{1} * C {[}_{etched Si} ] + {Factor}_{2} * C {[}_{NH 4 F} ] . \qquad ( eq . ( 1 ) )$$

For example, under the same etching conditions (SiO₂ concentration, mixing rate, temperature, etc.) besides the BHF sample, etched Si is only related to HF and NH₄F concentrations. When NH₄F concentration is consistent, etch rate is proportional to HF concentration at a certain range (e.g., 0-1000 ppm) based on an experimental observation. Ideally, Factor can be obtained by performing an experiment using BHF samples with various HF concentration but the same NH₄F concentration. Similarly, Factor₂ can be determined using samples with the same HF concentration but various NH₄F concentration. An offset for an adjustment of these experiment data can be determined via a calibration, where a standardized glassware is used to calibrate, and the offset is calculated by comparing the data in the standard calibration process with the actual data. Such a difference represents the offset. In these experiments, these samples with HF and NH₄F concentration are designed to be uncorrelated within a range, so that an appropriate data analysis technique, e.g., multi-variant fitting, can be applied using fewer samples to analyze how different variables between concentrations of HF and NH₄F affect an outcome of the experiment. Some typical etch reactions may be processed as in the below equation:

$${SiO}_{2} + 4 HF + 2 {NH}_{4} F = {( {NH}_{4} )}_{2} {SiF}_{6} + 2 {H}_{2} O \qquad ( eq . ( 2 ) )$$

In certain embodiments, a selective addition of NH₄F buffer allows a constant and controllable etch rate as well as spatially homogeneous etching:

$${NH}_{4} F + {H}_{2} O = {H}_{3} {O}^{+} + {F}^{-} + {NH}_{3} . \qquad ( eq . ( 3 ) )$$

### Example

This example provides a method to monitor high diluted HF in concentrated matrices, such as BHF with a high NH₄F/HF ratio (typically, NH₄F>15 wt. %, HF<1000 ppm). The example demonstrates the disclosed subject matter and its ability to provide an analysis capability for such BHF in an etched SiO₂ solution/bath.

In this example, 101 may include etching of SiO₂ by submerging a regular SiO₂ material (e.g., a quartz rectangular prism) with 20 mL of BHF sample solution in a sealed non-glass vessel for 30 minutes at room temperature with continuous mixing. The BHF may include a mixture of HF and NH₄F with a high diluted HF ratio: 200-1000 ppm HF and 16-18 wt. % NH₄F in the mixed solution. Selectively, the sample volume, mixing rotation rate, time, and temperature are maintained consistent across all the samples. These parameters can be further optimized if needed. The etching vessel is thoroughly rinsed with deionized water after sample removal for subsequent analysis.

Likewise, 102 may include measuring the above etched Si sample solution for Si concentration by either of the below methods, such as inductively coupled plasma optical emission spectroscopy (ICP-OES), inductively coupled plasma mass spectrometry (ICP-MS), and spectrophotometry, etc.

103 may include establishing a correlation of etched Si and HF in BHF solution. correlation for etched Si with HF concentration in the BHF sample solution can be calibrated. The correlation of etched Si concentration in five BHF samples with different HF concentration (200 to 1000 ppm) is established and calibrated by performing a series of experiments using the above standard etched sample solutions with BHF concentrations and measuring the etched Si concentrations.

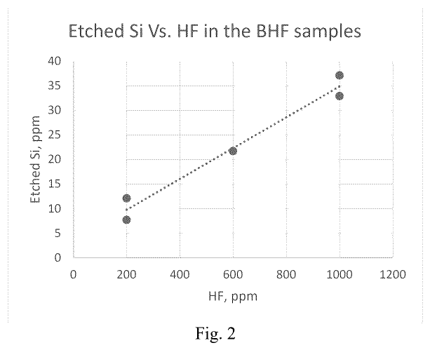

A typical correlation analysis includes plotting a graph with HF concentration on the x-axis and etched Sion the y-axis. Through statistical analysis to determine the correlation between HF concentration and etched Si, a positively and non-strictly linear correlation between etched Si and to BHF solution is established, with higher HF concentrations resulting in more etched Si and faster SiO₂ etching rates. The correlation has been validated and refined. As shown in FIG. 2, the correlation of etched Si with HF concentration in five BHF samples (listed in Table 1) is established accordingly. The deviation of coefficient of determination (R squared) from 1 is due to the various NH₄F concentrations. The effect from NH₄F can be determined by multivariant linear regression. A positively and non-strictly linear correlation has been validated for detecting, monitoring, and computing for HF analysis.

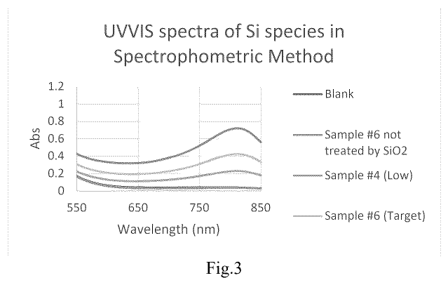

Furthermore, FIG. 3 shows a UV-VIS spectra of the BHF samples after being treated with chromophores that react with etched Si selectively. The intensity of the absorption peak is proportional to the concentration of etched Si in the BHF samples, thereby it correlates to the original HF concentration to be measured. Si detection by either method exhibits good agreement between measured and prepared HF, although the linearity of spectrophotometric method is lightly lower.

Additionally, an etch rate under the testing conditions in the example can be calculated based on etched Si, SiO₂ surface area, and etch duration. Alternatively, the etch rate of Si (from SiO₂) can be expressed in units of angstroms per minute (Å/min). This unit measures the rate at which a silicon layer is removed or etched over a specific period of time. An angstrom (Å) is a unit of length equal to 0.1 nanometers (nm). For example, an etch rate is calculated based on the etched Si, and SiO₂ surface area and etch duration.

Moving to 104, NH₄F concentration can be measured. The measurement of NH₄F in the BHF sample solutions is implemented by Near-infrared (NIR) spectroscopy to detect the concentration of NH₄F in the BHF solution. NIR spectroscopy is a non-destructive analytical technique that can provide information about the chemical composition of a sample based on its absorption of NIR light. The NIR spectroscopy readout for NH₄F concentration serves as one of the inputs parameters for calculating the final HF concentration in the BHF solution.

Illustrated in FIG. 2, the correlation of the obtained etched Si concentration against HF concentration also indicates that variation of NH₄F strength in the BHF sample solutions also affects the etched Si concentration. Selectively, in the example, NH₄F can be compensated into the BHF solution for avoiding a large variation during the monitoring.

As a result, the data performance of this example is demonstrated in Table 1 below. The sample solutions consist of 200-1000 ppm HF and 16-18 wt. % NH₄F in the solution.

TABLE 1

| | | | Etched | | | |
|---|---|---|---|---|---|---|
| | | | Si by | | | |
| | | Prepared | ICP- | | | Etching |
| | Prepared | NH4F, | OES, | Measured | Error, | rate, |
| Sample# | HF, ppm | w/w % | ppm | HF, ppm | ppm | Å/min |
| 4 | 200 | 16 | 7.7 | 203.5 | 3.5 | 7.1 |
| 5 | 200 | 18 | 12.1 | 206.7 | 6.7 | 11.1 |
| 6 | 600 | 17 | 21.7 | 580.9 | −19.1 | 20.0 |
| 7 | 1000 | 18 | 37.1 | 1002.9 | 2.9 | 34.1 |
| 8 | 1000 | 16 | 32.9 | 1006.1 | 6.1 | 30.3 |

As shown in the above table, the present data showing the concentration of HF in buffered hydrofluoric acid (BHF) through the measurement of etched Si concentration in the example reveals an error range (ppm) of less than 20 ppm or less than 5%,

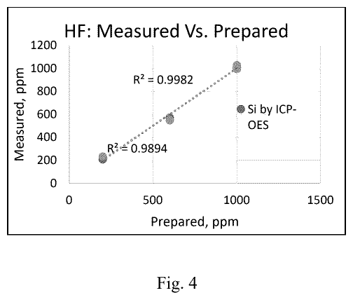

FIG. 4 shows a correlation of measured and prepared (predetermined concentration) HF in BHF samples, with two different detection methods of Si concentration, e.g., ICP-OES and spectral. Shown in FIG. 4, Si detection by either method exhibits a substantial agreement between the measured and prepared HF, although the linearity of the spectrophotometric method is lightly lower.

### Compared Examples

To demonstrate the accuracy and efficiency of the present measurement, different compared examples are presented.

A potentiometric titration for a BHF solution using NaOH is conducted. The BHF solution consists of HF and NH₄F (high level), having a large difference in pKa (e.g., End point 1: HF pKa=3.17, End point 2: NH₄F pKa=8.2). Hence, it is possible to titrate both of them only if their concentrations are comparable. The second end point will be weak due to NH₄F being a very weak acid. However, when the concentration of one component is much less than the other, the separation is poor. The Table 2 below lists the results of 0.1 mL of highly diluted BHF sample solution containing 500-1500 ppm of HF in 15 wt. % of NH₄F being titrated by 0.1N NaOH. The neutralization of HF (first end point) was significantly deviated from the expected value, leading to inaccurate quantification.

TABLE 2
Titration results of 500-1500 ppm of HF in
15 wt. % NH₄F by NaOH (Compared Example)

| | | | Theoretical | Measured | Theoretical | Measured 2^{nd} |
|---|---|---|---|---|---|---|
| | HF, | NH₄F, | 1^{st} End point | 1^{st} End point | 2^{nd} End point | End point volume |
| Sample # | ppm | wt. % | volume, mL | volume, mL | volume, mL | (very weak), mL |
| 1 | 500 | 15 | 0.025 | 0.6214 | 4.293 | 4.174 |
| 2 | 1000 | 15 | 0.050 | 0.638 | 4.293 | 4.149 |
| 3 | 1500 | 15 | 0.075 | 0.684 | 4.293 | 4.359 |

Another compared example is to correlate HF concentration to the pH value of the BHF sample solution. Three reactions happen in the NH₄F—HF—H₂O system with the equations shown below.

$$\begin{matrix}HF = {H}^{+} + {F}^{-} & ( K = 6.7 * {10}^{- 4} )\end{matrix} \qquad eq . ( 4 )$$

$$\begin{matrix}{HF}_{2}^{-} = HF + {F}^{-} & ( K = 0.26 )\end{matrix} \qquad eq . ( 5 )$$

$$\begin{matrix}{NH}^{4 +} = {NH}_{3} + {H}^{+} & ( K = 5.8 * {10}^{- 10} )\end{matrix} \qquad eq . ( 6 )$$

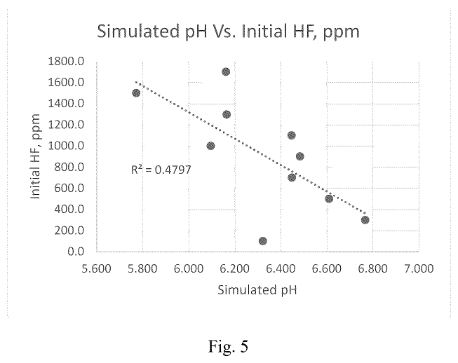

The proton concentration can be calculated from the dissociation constants and initial composition of HF and NH₄F. However, the calculated pH has a poor correlation to the initial HF concentration, as shown in FIG. 5. In addition, pH measurement can be problematic practically based on data from a polarity of samples, e.g., 10 samples, because pH electrode is composed of a glass sensing bulb which can be etched by the BHF sample, leading to unstable and unsustainable analysis.

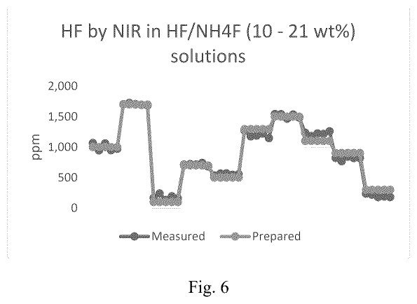

Another compared example based on 10 samples is conducted by Near Infrared (NIR) Spectroscopy combined with multivariant analysis and use of expensive HF resistant cuvettes/flow cells. It has been used to monitor both HF and NH₄F in the semiconductor manufacturing industry. However, in cases when HF is highly diluted and NH₄F concentration is high, the performance of HF analysis by NIR becomes poor as shown in FIG. 6, although NH₄F can still be measured. The error of HF determination can be as high as 150 ppm.

These compared examples reveal the following disadvantages: inability to quantify the diluted HF in samples containing high levels of NH₄F (e.g., titration methods), accuracy and repeatability being insufficient for user application (e.g., NIR method), utilization of complicated and costly hardware parts to avoid Quartz interference which is normally used in NIR instruments but will be etched by BHF samples (e.g., NIR method), or unsustainability of the hardware parts (e.g., pH ISE).

Contrary to those above compared methods presenting an inability to accurately and efficiently measure highly diluted HF in samples with concentrated matrices especially those containing alternative fluoride sources (such as NH₄F in BHF solutions), the exampled method of the disclosed matters for determining HF concentration through etched Si under controlled conditions enables its applications to determining or monitoring very diluted HF in concentrated matrices, such as BHF with a high NH₄F/HF ratio (NH₄F>15 wt. %, HF<1000 ppm), demonstrating an analysis capability superior to alternative techniques.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

What we claim is:

1. A method for monitoring of HF in buffered hydrofluoric acid (BHF) solution, comprising:
a). etching SiO₂ by using a BHF solution containing HF and NH₄F;
b). measuring Si concentration;
c). calibrating a correlation between the etched Si concentration and predetermined HF concentration in BHF solution;
d). measuring NH₄F concentration; and
e). determining HF concentration.

2. The method of claim 1, wherein the BHF solution comprises HF less than 1000 ppm.

3. The method of claim 1, wherein the BHF solution comprises NH₄F more than 15 wt. %.

4. The method of claim 1, wherein the Si concentration is measured by inductively coupled plasma optical emission spectroscopy (ICP-OES) or spectrophotometric technology.

5. The method of claim 1, further comprises calculating an etch rate at least based on the etched Si, surface area of SiO₂ and the etch duration time.

6. The method of claim 1, wherein the NH₄F concentration is measured by NIR spectroscopy.

7. The method of claim 1, wherein the correlation is linearly positive.

8. The method of claim 1, wherein the monitoring conditions are maintained consistent.

9. The method of claim 8, wherein the monitoring conditions comprise solution volume, mixing rotation rate, mixing time, and temperature.

10. The method of claim 1, further comprising compensating NH₄F into the BHF solution for avoiding a large variation during the monitoring.
